(19) United States
(12) Patent Application Publication
(10) Pub. No.: US 2004/0071277 A1
(43) Pub. Date: Apr. 15, 2004

(54) Multi-gateway communications system with switching control method

(76) Inventors: Ming Shan Shih, Hsin Chuang City (TW); Hsien Chuan Kuo, Chung Li City (TW); Chien Heng Chou, Tao Yuan Hsien (TW); Ching Shan Chao, Hsin Tien City (TW); Shih Chieh Kuo, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/266,607

(22) Filed: Oct. 9, 2002

(51) Int. Cl. H04M 11/00

(52) U.S. Cl. 379/93.07

(57) ABSTRACT

The invention relates to a kind of multi-gateway communications system and switching control method, especially a system that is able to combine traditional Public Switched Telephone Network(PSTN) with Voice over Internet Protocol(VoIP). The multi-gateway communications system, connecting a user end with a caller end, can be utilized for verifying if a call is coming through Internet or POTS and automatically switching to enable the call receiver to answer the call. Moreover, the multi-gateway communications system provides with at least two switch components for the user end to choose if s/he wants to make a call through either Internet or POTS.

### BACKGROUND OF THE INVENTION

(1) Field of the Invention

The invention relates to a multi-gateway communications system with switching control method, especially a system that is applicable to at least two telephone communications technologies allowing users to select from any one of the telephone communications modes for use.

(2) Description of the Prior Art

The prevalence of Internet network at present time has made it a new trend in transferring a large amount of data or information through Internet. Moreover, the progress of semi-conductors and computer software/hardware designs enable data to be transformed from voice into a digital data packet, the technology for which is matured enough to enable the digital packet to be transferred to a call receiver end from Internet. Therefore, the convenience of Internet utilization for Data and Voice transfer apparently and largely decreases the payments of telephone communications, especially, international or long distance calls for enterprises or personal users.

The existing Internet telephone system utilizes Internet voice packet transfer for achieving the purpose of telephone communications, however, the said system is unable to be combined with traditional plain old telephone service(POTS) network(as shown in FIG. 1). Thus, two sets of telephone devices have to be purchased if a user end has to make use of both systems at the same time(dialing or receiving), which situation rises some levels of inconveniences to general users, furthermore, the expenditure of purchasing two systems for use also one of the most concerns to general public.

### SUMMARY OF THE INVENTION

In view of the foregoing drawbacks, the main object of the invention is to propose a multi-gateway communications system that is able to put a combination of POTS and Voice over Internet Protocol(VoIP) to use by two different switch components set on a telephone set(e.g., any two press buttons, etc.) to enable a user to make a call through either Internet or POTS. Moreover, the disclosed system is able to verify a call is dialed through Internet or POTS, then automatically switches the system status properly, so that calls from different telephone systems are able to be received by the same telephone (as shown in FIG. 2). In addition, the invention will automatically switch the telephone system to the status of the traditional Public Switched Telephone Network (PSTN) for normal operations of dialing or receiving telephones, when there is a power failure occurred.

The detailed descriptions of the preferred embodiments are followed by the brief descriptions of the drawings below.

### BRIEF DESCRIPTION OF THE DRAWINGS

FIG. 1 is a schematic diagram of respective the utilization of POTS and Internet communications;

FIG. 2 is a systematic diagram of the co-existing communications systems in-between POTS and Internet;

FIG. 3 is a systematic structure of the multi-gateway communications system according to the invention;

FIG. 4 is a flowchart diagram of the call dialing process of the multi-gateway communications system of the invention;

FIG. 5 is a flowchart diagram of the call receiving process of the multi-gateway communications system of the invention;

FIG. 6 is a schematic diagram of the invention applying the multi-gateway communications system to a telephone set;

FIG. 7 is a switching control device with pluralities of ports for connecting to PSTN line and Internet telephone systems applying the multi-gateway communications system of the invention.

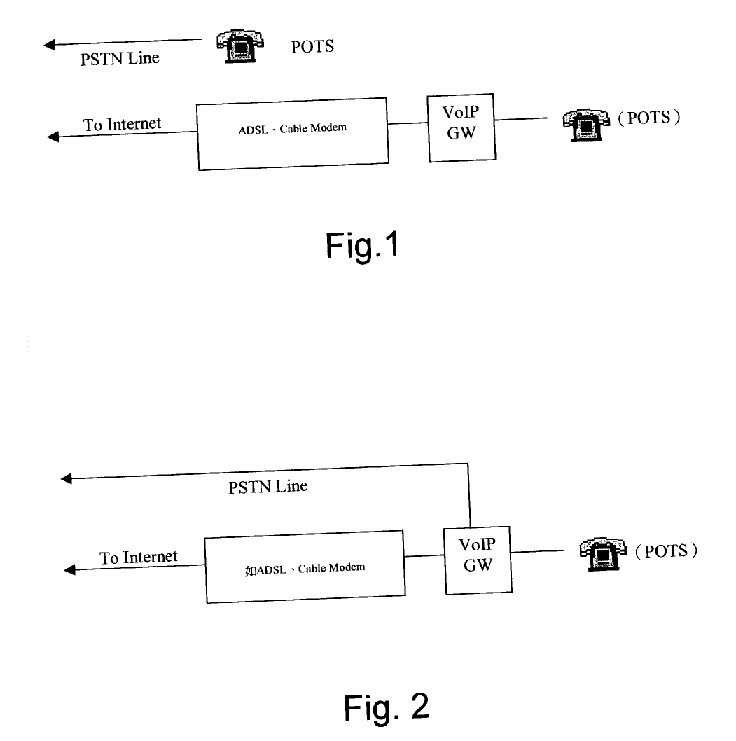

### DETAILED DESCRIPTION OF THE PREFERRED EMBODIMENTS

The invention focuses on a method of combining, switching and controlling in-between the systems of an external PSTN line and an Internet telephone, therefore, the system judgment and control and switch method will be further described hereinafter; whereas the matured and currently applied technologies of transforming voice signals into IP packets through Codec(Coder/Decoder), SLIC, DSP and CPU will not be further illustrated.

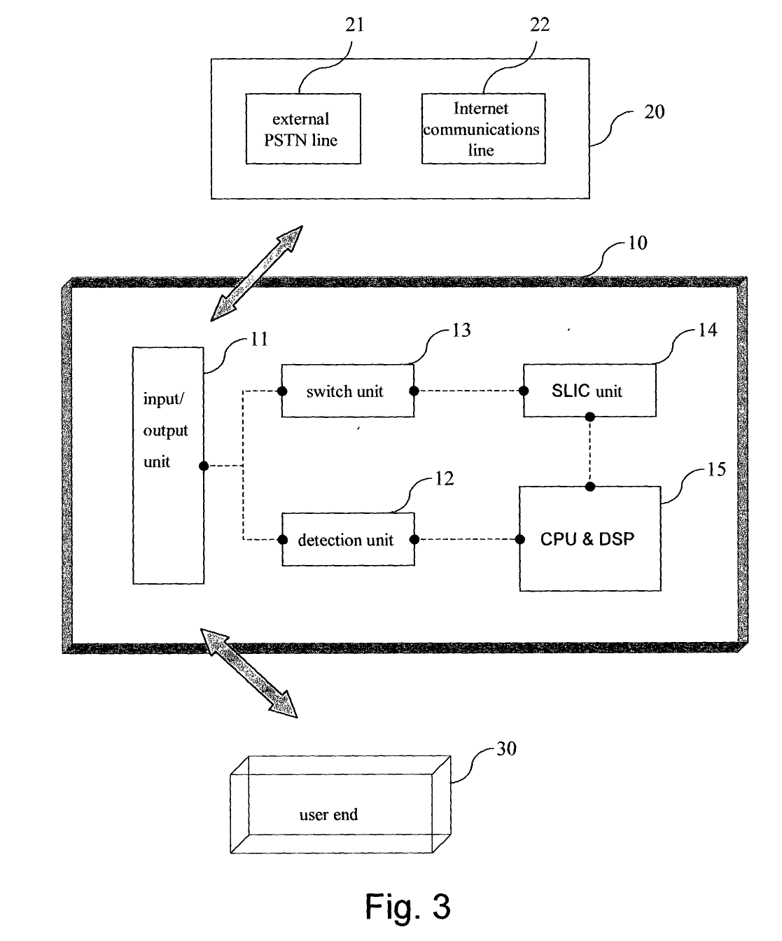

FIG. 3 is the systematic structure of the multi-gateway communications system according to the invention. The said system comprises an input/output unit 11, a detection unit 12, a switch unit 13, a SLIC unit 14 and a CPU & DSP 15. The units are further depicted as follows.

The input/output unit 11 is to enable the multi-gateway communications system 10 to carry out the function of telephone communications for a caller end 20 or a user end 30. The caller end 20 further comprises an external PSTN line 31 and an Internet communications line 32. The input/output unit 11 can be a telephone handset.

The detection unit 12 is to detect if the external PSTN line is connected, and if the input/output unit 11 is lifted by the user end. In the field of the detection of the external PSTN line, the invention mainly utilizes a bridge rectifier for detecting voltage of PSTN line through the Central Office (CO) end, in addition, and then utilizes a comparator and reverser for verifying if the line is connected and informing a CPU & DSP 15 of the result for further actions. Besides, the invention employs an optical coupler to be serially connected to the telephone line, so that when the input/output unit 11 is lifted or hung up, different electric currents flow through the optical coupler to generate different outputted voltages for achieving the detection of lifting or hanging up the input/output unit 11, the CPU & DSP 15 will then be informed of the detected result for further operations.

The switch unit 13 mainly connects the telephone line with the external PSTN line or a SLIC unit 14 by controlling Relay. The switch unit 13 integrates various statuses through the CPU & DSP 15 to verify the subsequent control Relay and switch in between two networks, PSTN line or to SLIC line, connecting to the multi-gateway communications system 10.

The SLIC unit 14 is to transform voice signals into digital signals, which then are transferred to the DSP for further processing. The SLIC unit 14 is also a control interface to a telephone set for the tasks of impedance matching, required voltage control, vibration and receiving and verifying the detection of pressed button, etc.

The CPU & DSP 15 further comprises two units of CPU and DSP. Digital voice signals are received by DSP to be compressed for further processing by CPU, and then, are packed into Ethernet packets to be transferred to a call receiver end through Internet or LAN. When a call receiver unit is a system, the same principle is applicable to the system that voice packets are received by Ethernet for being decompressed into information by CPU and restored to analogue voice packets by DSP and the SLIC unit 14. Another task of CPU is to send out the control command of switching lines and make appropriate switches based on the verifications of various situations, when a message is detected and received.

The switch and verification method of the preceding system is further detailed as follows.

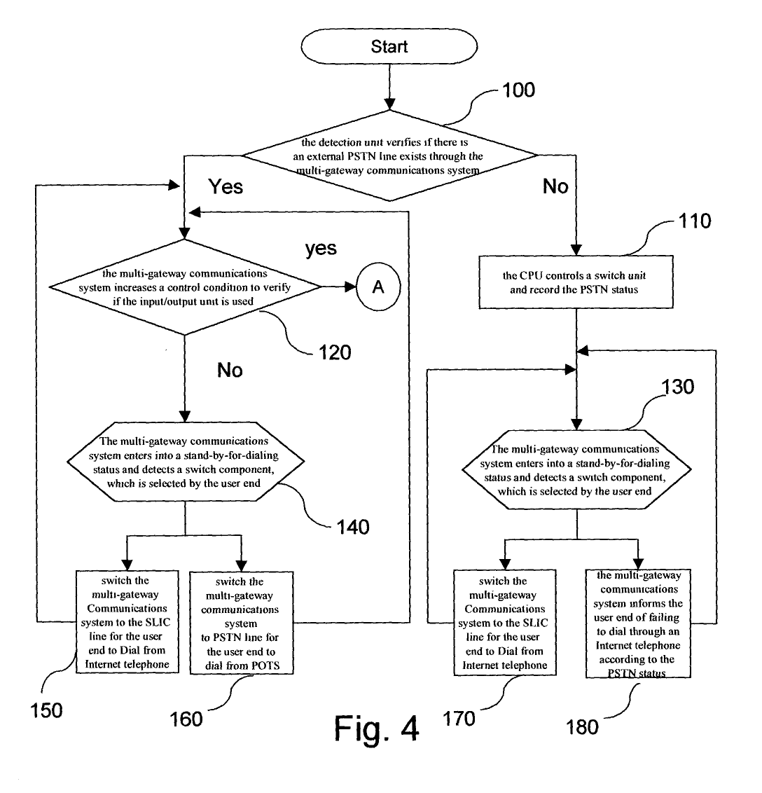

FIG. 4 is the flowchart diagram of the call dialing process of the multi-gateway communications system of the invention. First, the flow verifies if there is an external PSTN line exists by the detection unit 12 through the multi-gateway communications system 10(step 100). When the PSTN is disconnected, i.e., there is no an external line exists, the CPU & DSP 15 controls the switch unit 13 and record the PSTN status (step 110), and directly switches the telephone set to the SLIC line. Without any external line existence, a user can only dial up through an Internet telephone. The multi-gateway communications system 10 then enters into a stand-by-for-dialing status and detects a switch component, which is selected by the user end 30 (step 130), for dialing through either a POTS or an Internet telephone by the input/output unit 11.

When the user end hangs up the telephone set, the invention automatically detects and informs CPU of the status, in addition, restores the system to the stand-by-for-dialing status (step 110) waiting for the next telephone call dialing or receiving.

On the contrary, if there is any PSTN line being detected, the multi-gateway communications system 10 then increases a control condition to verify if the input/output unit 11 is used (step 120), if the telephone handset is lifted. If the input/output unit 11 is not under using, the multi-gateway communications system 10 enters into stand-by-for-dialing status and detects a switch component, which is chosen by the user end 30(step 140), waiting for the user end 30 to dial through either a POTS or an Internet telephone.

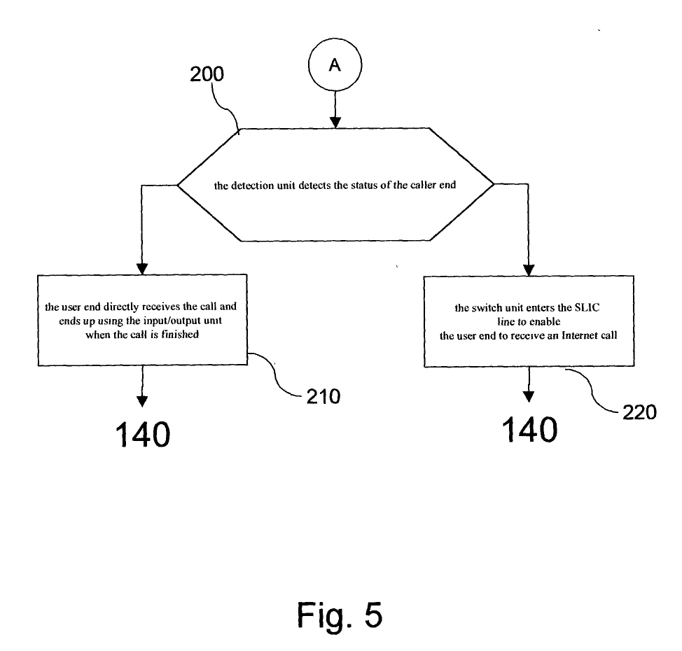

As shown in FIG. 5 that while the multi-gateway communications system 10 enters into a stand-by-for-dialing status waiting for receiving a call from the user end 30, through either a POTS or an Internet telephone, if the caller end 20 dials the user end 30 through POTS using the input/output unit 11 (step A), the detection unit 12 detects the status of the caller end 20 (step 200). If the call is dialed through POTS, the user end 30 directly receives the call and ends up using the input/output unit 11 when the call is finished(step 210), the flow then goes back to the preceding status of (step 120). If the multi-gateway communications system 10 receives telephone communications signals from the caller end 20 through an Internet telephone, it then enters into Internet telephone mode and switches to the SLIC line through the switch unit 13 to enable the user end 30 to receive an Internet call(step 220). At last, the system goes back to the preceding status of (step 120) when telephone communications end up.

Another situation is that assuming that both switch components are press buttons “0” and “#” on a telephone set, when the multi-gateway communications system 10 enters a stand-by-for-dialing status waiting for the user end 30 to choose a switch component (step 130 and 140) for dialing through either a POTS or an Internet telephone, the user end 30 can press either of the two press buttons as required and dial out through the input/output unit 11 through a POTS or an Internet telephone. Until the input/output unit 11 is hung up, the invention detects and informs CPU of the line status to restore the system to stand-by-for-dialing status of (step 120) waiting for the next telephone call dialing or receiving.

Another situation is that the multi-gateway communications system 10 enters a stand-by-for-dialing status and detects an existed PSTN line, at the same time, the user end 30 presses the button “#” (set to dial Internet telephone), the SLIC unit 14 then checks and informs the CPU & DSP 15, which then further informs the switch unit 13 of the status to switch the multi-gateway communications system 10 to the SLIC line for the user end 30 to dial from Internet telephone (step 150). On the contrary, if the user end 30 presses the button “0”, the multi-gateway communications system 10 switches to PSTN line for the user end 30 to dial from POTS (step 160). Until the input/output unit 11 is finished being used, CPU is informed of the detected line status to restore the system to the stand-by-for-dialing status of (step 120) waiting for the next telephone call dialing or receiving.

Another situation is that the multi-gateway communications system 10 does not detect any existed PSTN line, therefore, when the user end 30 presses the button “#”, s/he is able to dial out through an Internet telephone (step 170); whereas if s/he presses the button “0”, the multi-gateway communications system 10 then informs the user end 30 of failing to dial through an Internet telephone according to the PSTN status(step 180).

The aforementioned switch components can be defined by the user end 30 as any component of the multi-gateway communications system interface, e.g., any two press buttons of a telephone set.

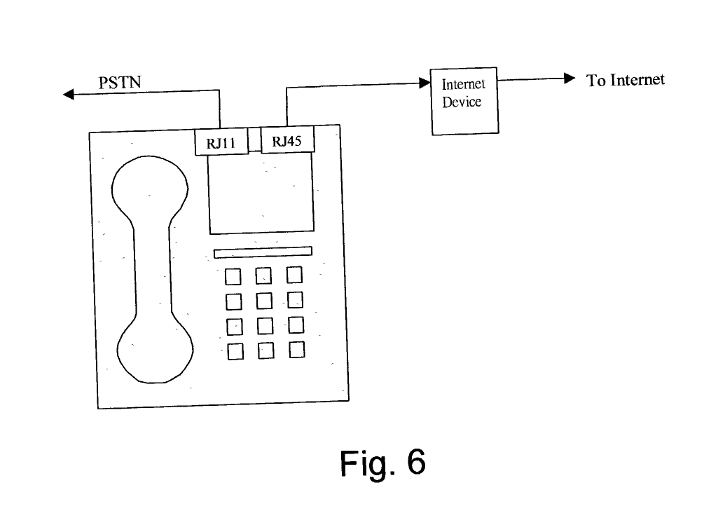

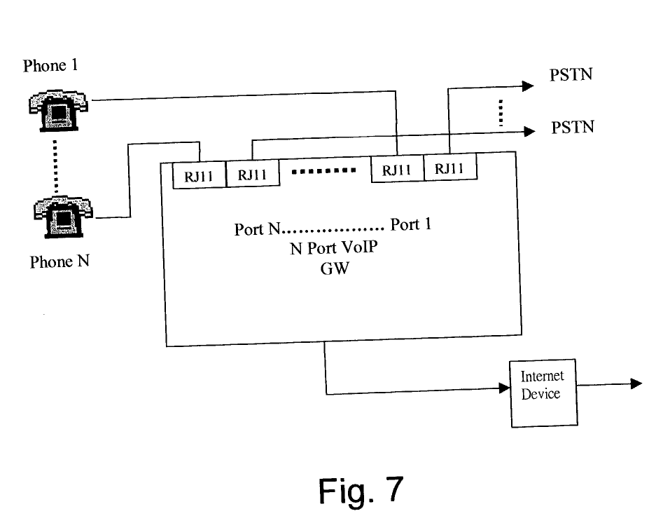

In view of the foregoing descriptions, it is of course to be understood that the embodiment of the disclosed switching control method between the systems of POTS and Internet communications is described herein to enable a user end to dial from different telephone communications system through a multi-gateway communications system 10, moreover, to save the expenditure of purchasing extra telephone set(s). In addition, the invention maintains the convenience of using POTS of a user. Besides, the invention is able to combine POTS with the said gateways making it a telephone set that can receive or dial a PSTN call through a POTS and an Internet telephone(as shown in FIG. 6), also a switching control device that enables to extend pluralities of PSTN lines with Ports and Internet telephone(as shown in FIG. 7).

However, the said embodiment is merely illustrative of the principles of the invention and that a wide variety of modifications thereto may be effected by persons skilled in the art without departing from the spirit and scope of the invention are as set forth in the following claims.

What is claimed is:

1. A kind of multi-gateway communications system and switching control method employs at least two switch components, which is provided by a multi-gateway communications system at a user end, to enable the multi-gateway communications system to use either an external PSTN line or access Internet communications; the method comprises the following steps:
verifying the PSTN line status through a detection unit provided by the multi-gateway communications system;
adding a control condition and verifying the using status of an input/output unit by the multi-gateway communications system;
entering a stand-by-for-dialing status and detecting a chosen switch component of the user end by the multi-gateway communications system; and
switching and completing a dialing task through the multi-gateway communications system.

2. The multi-gateway communications system and switching control method in accordance with claim 1, wherein the control condition is to control a receiving mode of the multi-gateway communications system.

3. The multi-gateway communications system and switching control method in accordance with claim 2, wherein the receiving mode further comprises the following steps:
detecting the status of a caller end through the detection unit; and
switching to a SLIC line through the switch unit to enable the user end receive a call from Internet.

4. The multi-gateway communications system and switching control method in accordance with claim 1, wherein the switch component can be self-defined as any one of components of the multi-gateway communications system interface by the user end.

5. The multi-gateway communications system and switching control method in accordance with claim 1, wherein the stand-by-for-dialing status can be divided into waiting for dialing from an Internet telephone and from POTS.

6. The multi-gateway communications system and switching control method in accordance with claim 5, wherein the step of waiting for dialing from Internet telephone enables the user to dial from an Internet telephone while the line is switched to the SLIC line through the multi-gateway communications system.

7. The multi-gateway communications system and switching control method in accordance with claim 5, wherein the step of waiting for dialing from POTS enables the user end to dial from POTS while the line is switched to the PSTN line through the multi-gateway communications system.

8. A kind of multi-gateway communications system is to connect a user end and a caller end for achieving the purpose of communications; the device comprises:
an input/output unit, to provide the function of telephone communications between the caller end and the user end;
a detection unit, to detect if an external line is connected and if the input/output unit is occupied;
a switch unit, to switch to either an external PSTN line or a SLIC line for achieving the switches in-between two networks;
a SLIC unit, to transform voice signals into digital signals and provide at least two switch components; and
a CPU & DSP, to further process voice signals received by the SLIC unit, verify and send out the control command of switching lines and make appropriate switches.

9. The multi-gateway communications system in accordance with claim 8, wherein the caller end comprises an external PSTN line and an Internet communications line.

10. The multi-gateway communications system in accordance with claim 7, wherein the input/output unit can be a telephone handset.

11. The multi-gateway communications system in accordance with claim 7, wherein the switch components can be defined as one of components of the multi-gateway communications system interface by the user end.
